(19) United States
(12) Patent Application Publication
(10) Pub. No.: US 2006/0281849 A1
(43) Pub. Date: Dec. 14, 2006

(54) Coating compositions for forming a single inkjet-receptive layer on unsubbed textiles for direct inkjet printing with dye and pigment inks thereon

(75) Inventor: Edward Johnson, Pompton Lakes, NJ (US)

Correspondence Address: INTERNATIONAL SPECIALTY PRODUCTS;Attn: William J. Davis, Esq., Legal Department, Building No. 8, 1361 Alps Road, Wayne, NJ, 07470, US

(73) Assignee: ISP INVESTMENTS INC.

(21) Appl. No.: 11/151,091

(22) Filed: Jun. 13, 2005

(51) Int. Cl. B60C 1/00

(52) U.S. Cl. 524/492; 523/160

(57) ABSTRACT

This invention relates to inkjet printing on textile materials, and, more particularly to a composition for coating a single, inkjet-receptive layer onto unsubbed textiles such as canvas, polyester, linen and blends thereof, which accepts inkjet printing with dye and pigment inks and which gives strong colors which are water-resistant.

### CROSS-REFERENCE TO RELATED U.S. PATENTS AND APPLICATIONS

This invention is related to U.S. Pat. Nos. 6,872,787; 6,806,310; and U.S. patent applications Ser. No. 11/057,649, filed Feb. 14, 2005 and Ser. No. 10/926,519 filed Aug. 26, 2004, and U.S. Publication 2005/0027068A1; assigned to the same assignee as herein, the entire contents of which are incorporated by reference.

### BACKGROUND OF THE INVENTION

1. Field of the Invention

This invention relates to inkjet printing on textile materials, and, more particularly, coating compositions suitable for forming a single, inkjet-receptive layer on unsubbed canvas, polyester, linen and blends thereof, for the creation of banners, fine art prints and items such as bags, knapsacks and the like, by inkjet printing thereon.

2. Description of the Prior Art

The interest in inkjet printing on textiles has grown over the past few years. With the advent of pigmented inks, it is now possible to print on a wide variety of media and obtain images which do not fade and are very water-resistant. However, dye ink printing remains a problem since dye inks do not print well on textiles and are very easily washed off. In many instances, dye inks are preferred for their wide color gamut.

There is also a strong interest in printing on canvas for fine art as well as banners, and items such as bags and knapsacks. The problem with inkjet printing on canvas is that the raw canvas textile, due to its erose surface characteristic, must be coated with a “gesso” layer to give it whiteness and provide a surface which can be overcoated with an inkjet receptive coating. This makes the production a two-step coating operation. It is also necessary to calendar the gesso coating for smoothness and adhesion before the inkjet receptor layer is applied.

Accordingly, it would be of advantage to provide a single, inkjet-receptive coating which would adhere to canvas and be directly printable with a wide variety of inks to provide strong colors, and impart water resistance to images made with dye inks.

Another objective is to coat textiles including linen, polyester, cotton twill and cotton/poly blends and the like, with coating compositions which provide excellent image quality on the printed textile.

Among the other objects of this invention is to coat untreated canvas with a single layer that functions as both as a precoat and as a coating layer and accepts printing with both dye and pigment inks, to give strong colors which are highly water resistant.

These and other objects of the invention will be made apparent from the following description thereof.

### SUMMARY OF THE INVENTION

What is provided herein are coating compositions that provide a single layer (a matte coating) which adheres to an unsubbed textile substrate and allow printing with regular dye inks as well as pigment inks, to develop strong images which show excellent water resistance.

The coating compositions of the invention preferably include, by wt.,

(a) swellable, water-insoluble polyvinylpyrrolidone, 1-30%, preferably 10-20%;

(b) gel or fumed silica particles, 1-30%, preferably 10-20%;

(c) a crosslinkable vinyl lactam polymer, 25-96%; preferably 50-90%;

(d) a crosslinker therefor, 1-20%; preferably 5-15%;

(e) a binder, 1-30%; preferably 10-25%, and

(f) water.

Suitably (a) is crosslinked polyvinylpyrrolidone (PVPP), e.g. ViviPrint™ PS-10 (International Specialty Products—ISP) which is swellable up to 1.8×its volume and displays a mildly cationic characteristic. The uncrosslinked, or water soluble polyvinylpyrrolidone (PVP) is not suitable for use in this composition.

The silica component of the composition (b) is either a silica gel or fumed silica. Preferably silica gel which has a high internal porosity is used for enmeshing the PVPP particles, and, typically, has an average particle size of about 3-16 μm. A suitable silica gel is sold as Silcron® (Millenium Chemical Co.) which has an average particle size of 5 μm.

Fumed silicas, while having little or no internal porosity, have a plurality of chain-like particles with jagged edges which stick together to form agglomerate particle chains which readily permit attachment to the crosslinked polyvinylpolypyrrolidone particles. The BET surface area of fumed silica reflects overwhelmingly external surface area and little internal porosity. A typical fumed silica has a BET surface area of 380 m²/g, a high bulk density and a particle size in the range of 0.05-0.12 μm.

The combination of PVPP and gel or fumed silica is microporous in nature and its structure presents a honeycomb of pores to receive the ink. Such an admixture thus achieves high ink absorbing speed, i.e. fast drying times, and image permanence without swelling the paper.

The crosslinkable vinyl lactam polymer component (c) of the invention composition preferably is a terpolymer of vinyl caprolactam (VCL), dimethylaminopropyl methacrylamide (DMAPMA) and hydroxyethyl methacrylate (HEMA), unquaternized or quaternized, in a terpolymer compositional range, by wt., 60-90% VCL, 10-30% DMAPMA and 2-10% HEMA, most preferably 75-80% VCL, 13-16%, DMAPMA and 4-6% HEMA.

The crosslinker component (d) may be conventional crosslinkers known in the art, e.g. polyepoxides, e.g. Ancarez® AR 550; melamine/formaldehyde resins, e.g. Berset 2003; and aziridines. Ancarez® 550 is preferred.

The binder component (e) also may be binders known in the art, e.g. latex, polyvinyl alcohol, gelatin, PVP, PVP copolymers, to assist in holding the composition together.

Optional components include pigments, such as clays, alumina, calcium carbonate, and starch and surfactants. Preferred pigments include, but are not limited to, various clays such as cationic clays. Preferred surfactants include, but are not limited to, non-ionic surfactants.

The synergistic compositions of the invention in water provide an advantageous increase in viscosity. The compositions can be readily converted into a homogeneous dispersion.

Preferably the coating composition of the invention has a viscosity of about 200 to 1000 cps, preferably 600 cps (70 rpm, #64 spindle); about 10-30% solids, preferably 24%; and has a pH of about 8-10, preferably 9.

### DETAILED DESCRIPTION OF THE INVENTION

The coating composition of the invention is characterized by a defined formulation which combines a mixture of organic and inorganic pigments with a blend of unique polymers, a crosslinker and a binder, in a water dispersion. The polymers provide excellent binding and ink receptivity. The polymers also can be crosslinked to provide enhanced water resistance. The binders help in adhesion and flexibility, as well as water resistance. The pigments provide the absorbing and whitening matrix.

A particular characteristic of the invention composition is its ability to form a single inkjet-receptive layer on unsubbed textiles, e.g., canvas. Inkjet printing with both dye and pigment inks directly on this layer provides the desired image.

Since the printing ink will print directly on the single coating applied to the fibers by the composition of the invention, the printing process does not require a reactive dye ink to be applied with the fiber. In this invention, the coating will adhere directly to the fabric and be receptive immediately for direct printing therein. The resultant product is water-resistant.

The invention will now be described by reference to the following examples.

### EXAMPLE 1

### Coating Composition of Invention

TABLE 1

| Amount % (by wt.) | | |
|---|---|---|
| Suitable | Preferred | Optimum |

Essential Ingredients

| | | | | |
|---|---|---|---|---|
| (a) | Crosslinked polymer-PVPP | 1-30 | 10-20 | 15 |
| | (e.g. ViviPrint ™ PS-10 ISP) | | | |
| (b) | Silaceous gel silica | 1-30 | 10-20 | 15 |
| | (e.g. Silcron ® G-100) | | | |
| (c) | Crosslinkable vinyl lactam | 25-95 | 50-90 | 80 |
| | polymer- e.g. | | | |
| | VCL/HEMA/DMAPMA | | | |
| | (ViviPrint ™ 200 ISP) | | | |
| (d) | Crosslinker (e.g. ANCAREZ ® | 1-20 | 5-15 | 9 |
| | 500) | | | |
| (e) | Binder- (e.g. UCAR ® 313 | 1-30 | 10-25 | 15 |
| | Latex water resistance) or vinyl | | | |
| | lactam copolymer | | | |
| | (ViviPrint ™ 650 ISP) | | | |
| (f) | Water | qs | qs | 210 |

| | | | |
|---|---|---|---|
| Optional Ingredients - Other | | | |
| Clay - (Digitex ® 1000) (cationic) | 0-30 | 10-30 | 20 |
| Surfactant (10 G) | 0-10 | 0.5-2 | 1 |

Process:
Form a slurry of (a) and (f) for 10 minutes.
Mix (b) therein for 10 minutes.
Add (c), (d) and (e).

### EXAMPLE 2

TABLE 2

| Ingredient | | Wt. | |
|---|---|---|---|
| (a) | ViviPrint ™ PS-10 | 2.2 | g |
| (b) | SILCRON ® G 100 | 2.2 | g |
| (c) | ViviPrint ™ 200 | 10 | g |
| (d) | AQUAZOL ® 200 (30%) | 2 | g |
| | NEOCRYL ® CX 100 | 0.2 | g |
| (e) | DISPAL ® 11N7-12 (Alumina) | 8 | g |
| | DIGITEX ® 1000 | 2 | g |
| | Calcium Carbonate (7 micron) | 4 | g |
| | Water at pH 9 with Ammonium Hydroxide | 42 | g |

### EXAMPLE 3 (TEST RESULTS)

The compositions above were coated with a 38 Meyer rod onto raw textile materials, including unsubbed canvas, linen, polyester, cotton, cotton twill and blends thereof. Single, adherent coatings were obtained. The coating weights were 16-24 g/m². Then the coated substrate was printed directly with both dye and pigment inks from HP and Epson printers. The printed articles gave vivid colors which dried instantly. With printed inks, a one-hour water test with stirring showed <2% density loss. Hot water washing with soap gave similar results. Xenon fade with pigments was zero and with dyes was equal to normally observed fading on paper coated with similar polymers.

While the invention has been described with particular reference to certain embodiments thereof, it will be understood that changes and modifications may be made which are within the skill of the art.

What is claimed is:

1. A coating composition for forming a single layer directly on unsubbed textiles suitable for inkjet printing with dye and pigment inks, comprising, by weight %,
(a) a crosslinked vinyl lactam polymer or copolymer, 1-30,
(b) gel or fumed silica, 1-30,
(c) a crosslinkable vinyl lactam polymer, 25-95,
(d) a crosslinker therefor, 1-20,
(e) a binder, 1-30, and
(f) water.

2. A coating composition according to claim 1 wherein (a) is 10-20; (b) is 10-20; (c) is 50-90; (d) 5-15 and (e) 10-25.

3. A coating composition according to claim 1 wherein (a) is 15, (b) is 15; (c) is 80; (d) is 9; and (e) is 15.

4. A coating composition according to claim 1 wherein (a) is crosslinked polyvinylpyrrolidone (PVPP).

5. A coating composition according to claim 1 wherein (b) is silica gel.

6. A coating composition according to claim 5 wherein said silica gel has an average particle size of 3-16 μm.

7. A coating composition according to claim 1 having a viscosity of 200-1000 cps (70 rpm, # 64 spindle).

8. A coating composition according to claim 1 which is about 10 to 30% solids.

9. A coating composition according to claim 1 which has a pH of about 8-10.

10. A coating composition according to claim 1 which includes clay or a surfactant.
